(19) United States
(12) Patent Application Publication
(10) Pub. No.: US 2016/0017732 A1
(43) Pub. Date: Jan. 21, 2016

(54) Off-Cambered Vanes for Gas Turbine Engines

(71) Applicant: United Technologies Corporation, Hartford, CT (US)

(72) Inventor: Flavien L. THOMAS, Moodus, CT (US)

(21) Appl. No.: 14/767,738

(22) PCT Filed: Feb. 24, 2014
(86) PCT No.: PCT/US2013/076050

§ 371 Date: Aug. 13, 2015

Related U.S. Application Data
(60) Provisional application No. 61/790,318, filed on Mar. 15, 2013.

(51) Int. Cl. F01D 9/04; F01D 25/24; F02C 3/04

(52) U.S. Cl. CPC F01D 9/041; F02C 3/04; F01D 25/24; F05D 2220/32; F05D 2240/12; F05D 2240/35

(57) ABSTRACT

An off-cambered vane for a guide vane assembly in a gas turbine engine is described. The guide vane assembly may comprise a nominal vane having a tip portion, a mid-span portion, and a hub portion. The mid-span portion of the nominal vane may adopt a nominal geometry and the hub portion of the nominal vane may adopt a common geometry. The guide vane assembly may further comprise an off-cambered vane having a tip portion, a mid-span portion, and a hub portion. The mid-span portion of the off-cambered vane may deviate variably with respect to the nominal geometry and at least one of the hub portion and the tip portion may adopt the common geometry.

### CROSS-REFERENCE TO RELATED APPLICATION

This patent application is a US National Stage under 35 U.S.C. §371, of International Application No. PCT/US13/76050 filed on Dec. 18, 2013, which claims priority under 35 U.S.C. §119(e) to U.S. Patent Application Ser. No. 61/790,318 filed on Mar. 15, 2013.

### FIELD OF DISCLOSURE

The present disclosure generally relates to guide vane assemblies of gas turbine engines and, more specifically, relates to vanes having common geometries at the tip and/or hub portions of the vanes.

### BACKGROUND

Gas turbine engines, such as jet engines, are internal combustion engines that utilize gas or air as the working fluid. The upstream to downstream arrangement of a gas turbine engine generally consists of a fan, a compressor section, a combustor section, a turbine section connected to the fan and the compressor section on a shaft, and an exhaust section. In operation, air is drawn into the engine and is accelerated by the fan, a fraction of which is passed to the compressor section (primary airflow) and another fraction of which is directed through a bypass duct around the engine (bypass airflow). Air directed to the compressor section via the primary airflow path is pressurized in the compressor section and is then directed to the combustor section where it is mixed with fuel and combusted. The hot combustion gases subsequently expand and enter the turbine section which converts kinetic energy from the expanding gases leaving the combustor section into mechanical energy to drive the compressor and the fan through rotation of an interconnecting shaft. After passing through the turbine section, the air is expelled through an exhaust nozzle to produce some propulsive thrust to an associated aircraft. The majority of the propulsive thrust, however, is provided by air flowing out from the bypass duct through a secondary nozzle.

The direction of airflow running past the fan in the bypass duct may initially be oriented at an angle with respect to the central axis of the engine, but may subsequently be straightened to produce airflow running parallel to the engine central axis by the operation of a guide vane assembly positioned around the circumference of the engine in the bypass duct. However, physical obstructions located downstream of the guide vane assembly may act to distort the directionality of the airflow and cause back pressure in the bypass duct and resulting strain on the blades of the fan. Such physical obstructions may include the pylon used to mount the engine to the wing of the aircraft, radial struts located downstream of the guide vane assembly, as well as other components.

Methodologies have been developed to counterbalance back pressure caused by obstructions located downstream of the guide vane assembly in order to ameliorate strain on the fan. In particular, current methodology, as described in U.S. Pat. No. 7,444,802, utilizes vanes of varying cambers, or off-cambered vanes, in the guide vane assembly to direct airflow in the bypass duct around any known obstructions. By this strategy, the off-cambered vanes may act by turning airflow by varying degrees, such as −10° to +10°, with respect to a standard nominal vane that is designed, on average, to direct airflow in a direction parallel to the engine central axis. Varying cambers are introduced into the off-cambered vanes by varying the position of the trailing edge with respect to the position of the trailing edge of a nominal vane, while keeping the position of the leading edge consistent across all vane classes. Such camber variation is generally introduced along the full span of the trailing edge (i.e., from the guide vane tip to the guide vane hub). By strategically arranging nominal vanes and off-cambered vanes in the guide vane assembly by taking into account known physical obstructions in the bypass duct flow path, it is possible to minimize the back pressure effects cause by downstream obstructions.

One drawback of the camber variation method is that for each type of guide vane geometry (or camber), separate tip and hub platforms which form the outer and inner endwalls of the guide vane assembly, respectively, must be individually designed and manufactured in order to provide matching slot configurations for receiving each type of vane tip and hub geometry. This necessarily increases the complexity of engine design and construction as well as the number and cost of required parts. Moreover, when using vanes with varying geometries, the geometry of the passages between adjacent guide vanes may vary depending on the cambers of the adjacent guide vanes such that components needing to fit between two vanes should be designed and scaled according to each combination of adjacent vanes. For example, part design complexity and resulting costs are further amplified when including contoured outer or inner endwalls in the guide vane assembly structure.

Clearly, a system is needed to reduce part numbers and associated costs for the construction of gas turbine engines utilizing off-cambered vanes.

### SUMMARY OF THE DISCLOSURE

In accordance with one aspect of the present disclosure, a guide vane assembly for a gas turbine engine is disclosed. The guide vane assembly may comprise a nominal vane having a tip portion, a mid-span portion, and a hub portion. The mid-span portion may adopt a nominal geometry and the hub portion may adopt a common geometry. The guide vane assembly may further comprise an off-cambered vane having a tip portion, a mid-span portion, and a hub portion. The mid-span portion of the off-cambered vane may have a geometry deviating variably with respect to the nominal geometry. At least one of the hub portion and the tip portion of the off-cambered vane may adopt the common geometry.

In another refinement, the nominal geometry may be configured to assist directing airflow in a direction parallel to a central axis of the gas turbine engine.

In another refinement, the guide vane assembly may further comprise lower platforms having identical geometries and the hub portions of the nominal vane and the off-cambered vane may each be receivable by a respective one of the lower platforms.

In another refinement, the guide vane assembly may further comprise equivalent geometries proximal to adjacent hub portions.

In another refinement, the off-cambered vane may be configured to assist directing airflow at variable angles with respect to the central axis of the gas turbine engine.

In another refinement, the tip portion of the off-cambered vane may have a geometry that deviates variably with respect to the nominal geometry.

In another refinement, both the tip portion and the hub portion of the off-cambered vane may adopt the common geometry.

In another refinement, the common geometry may be the nominal geometry.

In another refinement, the tip portions of the nominal vane and the off-cambered vane in the guide vane assembly may each be receivable by identical upper platforms having identical geometries.

In accordance with another aspect of the present disclosure, an off-cambered vane for a guide vane assembly of a gas turbine engine is disclosed. The off-cambered vane may comprise a tip portion, a mid-span portion that may have a geometry that deviates variably with respect to a nominal geometry, and a hub portion that may adopt the nominal geometry.

In another refinement, the hub portion of the off-cambered vane may be receivable by a lower platform configured to receive a hub portion of a nominal vane.

In another refinement, the tip portion of the off-cambered vane may have a geometry that deviates variably with respect to the nominal geometry.

In another refinement, the tip portion of the off-cambered vane may adopt the nominal geometry.

In another refinement, the tip portion of the off-cambered vane may be receivable by an upper platform configured to receive a tip portion of a nominal vane.

In accordance with another aspect of the present disclosure, a gas turbine engine is disclosed. The gas turbine engine may have a fan, a compressor downstream of the fan, a combustor downstream of the compressor, a turbine downstream of the combustor, and a nacelle surrounding the fan, the compressor, the combustor, and the turbine. The gas turbine engine may further comprise a guide vane assembly which may be located between the nacelle and the fan, the compressor, the combustor, and the turbine. The guide vane assembly may comprise a nominal vane and an off-cambered vane. The off-cambered vane may have a tip portion, a mid-span portion, and a hub portion. The mid-span portion of the off-cambered vane may have a geometry that deviates variably with respect to a nominal geometry and at least one of the hub portion and the tip portion of the off-cambered guide vane may adopt a common geometry. The gas turbine engine may further comprise lower platforms having identical geometries and each lower platform may receive the hub portion of a respective one of the nominal vane and the off-cambered vane.

In another refinement, the common geometry may be the nominal geometry.

In another refinement, the tip portion of the off-cambered vane may have a geometry that deviates variably with respect to the nominal geometry.

In another refinement, both the tip portion and the hub portion of the off-cambered vane may adopt the common geometry.

In another refinement, the gas turbine engine may further comprise upper platforms having identical geometries and each upper platform may receive the tip portion of a respective one of the nominal vane and the off-cambered vane.

### BRIEF DESCRIPTION OF THE DRAWINGS

FIG. 1 is a cross-sectional view of a gas turbine engine constructed in accordance with the present disclosure.

FIG. 2 is a schematic representation of airflow directional influences through the fan and into a bypass duct of a gas turbine engine in accordance with the present disclosure.

FIG. 3 is a front view of a guide vane assembly constructed in accordance with the present disclosure.

FIG. 4 is a perspective view of an isolated vane attached to an upper platform and a lower platform.

FIG. 5 is a fragmentary perspective view of the section 3-3 of FIG. 3.

FIG. 6 is a cross-sectional view through the section 5-5 of FIG. 5, illustrating representative varying hub geometries in an exemplary vane sequence.

FIG. 7 is a cross-sectional view through the section 6-6 of FIG. 5, illustrating representative varying mid-span geometries in the exemplary sequence of FIG. 6.

FIG. 8 is a cross-sectional view through the section 7-7 of FIG. 5, illustrating representative varying tip geometries in the exemplary sequence of FIG. 6.

FIG. 9 is a cross-sectional view through the section 5-5 of FIG. 5, illustrating common hub geometries in an exemplary vane sequence, in accordance with the present disclosure.

FIG. 10 is a cross-sectional view through the section 6-6 of FIG. 5, illustrating varying mid-span geometries in the exemplary sequence of FIG. 9.

FIG. 11 is a cross-sectional view through the section 7-7 of FIG. 5, illustrating varying tip geometries in the exemplary sequence of FIG. 9.

FIG. 12 is a cross-sectional view through the section 5-5 of FIG. 5, illustrating varying hub geometries in an exemplary vane sequence, in accordance with the present disclosure.

FIG. 13 is a cross-sectional view through the section 6-6 of FIG. 5, illustrating varying mid-span geometries in the exemplary sequence of FIG. 12.

FIG. 14 is a cross-sectional view through the section 7-7 of FIG. 5, illustrating common tip geometries in the exemplary sequence of FIG. 12.

FIG. 15 is a perspective view of a nominal vane constructed in accordance with the present disclosure.

FIG. 16 is a perspective view of a modified off-cambered vane having a minus ten geometry at the tip portion and the mid-span portion and a nominal geometry at the hub portion constructed in accordance with the present disclosure.

FIG. 17 is a perspective view of the nominal vane of FIG. 15 overlapped with the modified off-cambered vane of FIG. 16.

FIG. 18 is a flow chart diagram, illustrating steps involved in the manufacture of the guide vane assembly, in accordance with the present disclosure.

It should be understood that the drawings are not necessarily drawn to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments disclosed herein.

### DETAILED DESCRIPTION

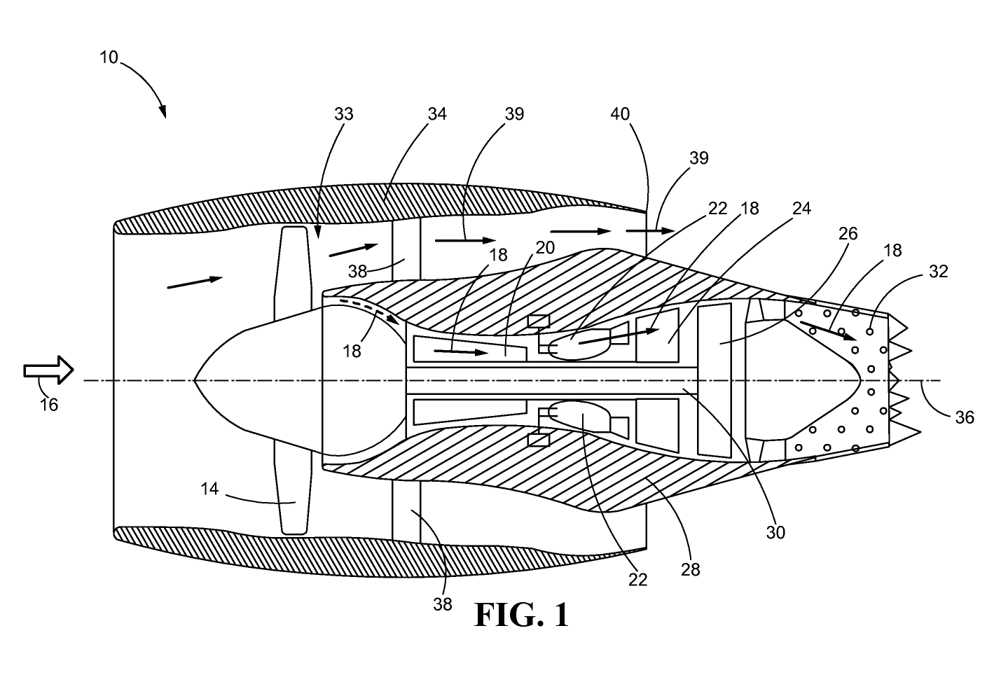

Referring now to the drawings, and with specific reference to FIG. 1, a cross sectional view of a gas turbine engine 10 is shown. The gas turbine engine 10 may have a fan 14 which may be involved in accelerating incoming air 16 through the engine 10 in an upstream to downstream direction, as shown.

In normal operation, air 16 may be drawn into the gas turbine engine 10 and may be accelerated by the fan 14. After passing the fan 14, a part of the incoming air 16 may be routed through a primary pathway 18 and another part may be directed through a bypass pathway (see below). In an upstream to downstream direction, the primary pathway 18 may be defined by a compressor section 20 (which may include both a low pressure compressor and a high pressure compressor), combustors 22, and turbines 24 and 26, as shown. The compressor section 20, combustors 22, and turbines 24 and 26 may be encased in an engine case 28. Incoming air 16 routed through primary pathway 18 may first be compressed and pressurized in the compressor section 20 and may subsequently be delivered to combustors 22 where the air is mixed with fuel and is combusted. The hot combustion products may then expand through and drive the turbines 24 and 26 which may, in turn, drive the compressor section 20 and the fan 14 by driving the rotation of an interconnecting shaft 30. After passing through the turbines 24 and 26, the air may be exhausted through an exhaust nozzle 32 to provide some, for example about 20%, of propulsive thrust to an associated aircraft.

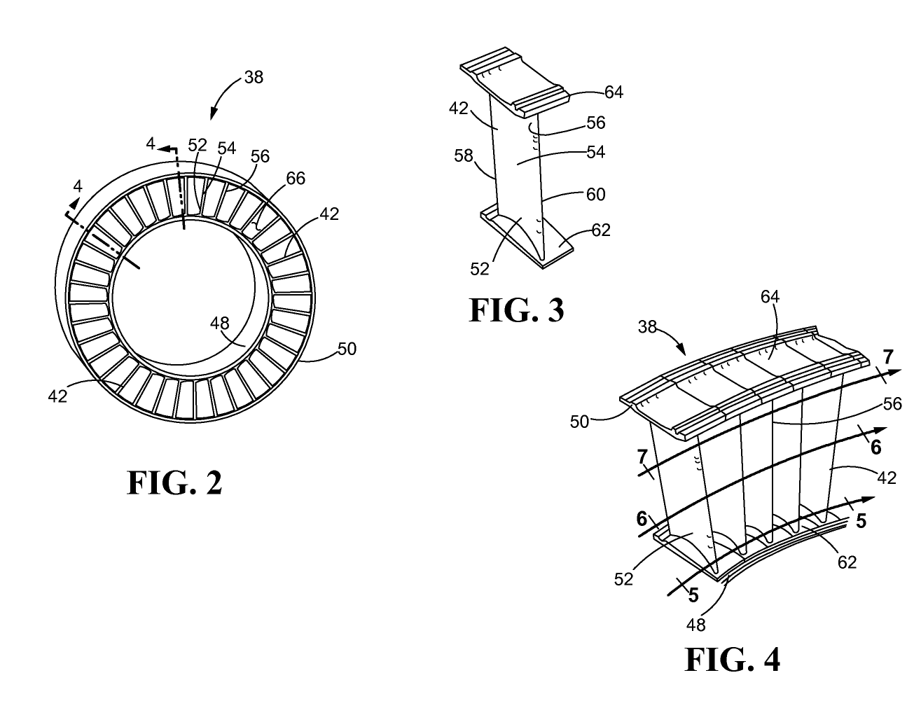

As shown in FIG. 1, the bypass pathway may be defined by a bypass duct 33 that may be formed by the circumferential space between the engine case 28 and a fan nacelle 34. When the incoming air 16 first passes the fan 14, it may initially be flowing in an upstream to downstream direction, but at an angle with respect to the engine central axis 36 (see FIG. 2). However, after passing through a guide vane assembly 38 located in the bypass duct 33, the incoming air 16 flowing through the bypass pathway may be straightened to produce airflow running parallel to and circumferentially about the engine central axis 36, as shown by arrowheads 39. The incoming air 16 passing through the bypass pathway via the bypass duct 33 may then exit the engine 10 through a nozzle 40 to produce the remainder of the propulsive thrust, for example about 80%, to the associated aircraft.

A schematic representation of airflow directional influences in the bypass duct 33 is illustrated in FIG. 2. The incoming air 16 may enter the engine 10 by passing through fan blades 44 (schematically illustrated in cross-section in FIG. 2) of fan 14, which may rotate and direct incoming air 16 at an angled direction with respect to engine axis 36, as illustrated by arrowheads 46. The incoming air 16 flowing in direction 46 may then be presented to the guide vane assembly 38 at such an angle. The guide vane assembly 38 (schematically illustrated in cross-section in FIG. 2) may include nominal vanes 66 (see detail 2A of FIG. 2) that may, on average, direct airflow to a direction running parallel to the engine axis 36, as shown by arrowheads 39. However, air flowing downstream of the guide vane assembly 38 in the bypass duct 33 may encounter obstructions 52 that may distort the directionality of the airflow and produce a back pressure 54, as shown. The resulting back pressures 54 may cause strain on the blades of the fan 14. The obstructions 52 may include the pylon 12, radial struts, or any other objects located downstream of the guide vane assembly 38.

In order to assist reducing the back pressure 54 caused by any known obstructions in the bypass duct 33, off-cambered vanes 53 may also be introduced into the guide vane assembly. The off-cambered vanes 53 may have cambers (or geometries) that deviate variably with respect to the camber of a standard nominal vane 66 having a nominal geometry 84 (see detail 2A of FIG. 2 and FIGS. 6-8). The off-cambered vanes 53, by virtue of their cambers (or geometries) that deviate variably with respect to a nominal geometry, may turn the airflow by varying subtle angles, such as by about −10° to about +10°, from an axial direction running parallel to to the engine axis 36 in order to guide airflow around any obstructions 52.

As shown in detail 2A of FIG. 2, the varying cambers of the off-cambered vanes 53 arise from variations in the position of the trailing edge 56 with respect to the position of the trailing edge 56 of the nominal vane 66. However, the position of the leading edge 60 remains constant across all vane classes, both nominal and off-cambered, as shown in detail 2A. A minus ten vane 64, for example, may be an off-cambered vane 53 that may have a minus ten geometry 86 (see FIGS. 6-8) characterized by a specific camber that deviates from the nominal geometry 84 and may turn airflow by about −10° with respect to an axial direction running parallel to the engine axis 36. Similarly, a plus ten vane 62 may have a plus ten geometry 88 (see FIGS. 6-8) characterized by a specific camber that deviates with respect to the nominal geometry 84 and may turn airflow by about +10°. Accordingly, several off-cambered vane classes having varying cambers, such as, but not limited to, minus two vanes, minus six vanes, plus two vanes, plus six vanes, etc., may be provided in this way for directing airflow by varying degrees around any known obstructions 52 in the bypass duct 33. In practice, off-cambered vanes 53 may be arranged with nominal vanes 66 in a strategic sequence in the guide vane assembly 38 to minimize the back pressure distortion at the fan trailing edge, the off-cambered vanes 53 acting to (on average) direct airflow around any known obstructions 52 in the bypass duct and the nominal vanes 66 acting to (on average) direct airflow in a direction parallel to the engine axis 36 (direction 39).

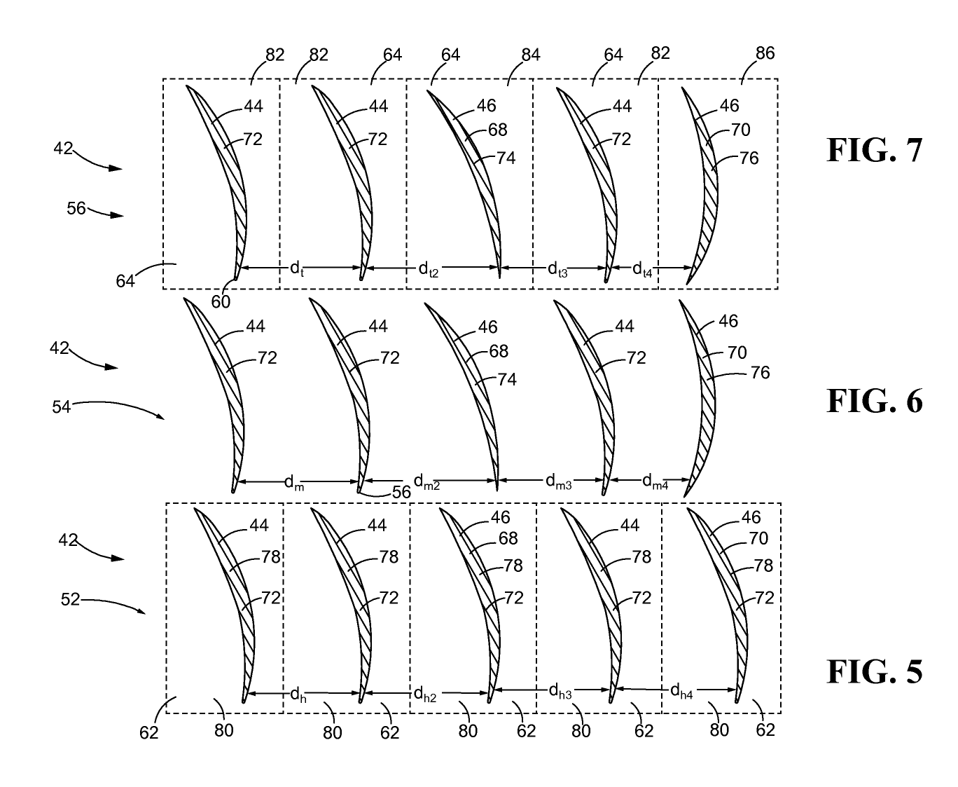

FIGS. 3-5 provide depictions of the configurations of the guide vane assembly 38 in accordance with the present disclosure. The guide vane assembly 38 may have a plurality of vanes 48, which may include nominal vanes 66 and/or off-cambered vanes 53 arranged in a sequence. Each vane 48 in the guide vane assembly 38 may be disposed between an inner endwall 68 and an outer endwall 70. Each vane 48 may have a hub portion 72, a mid-span portion 74, and a tip portion 76, as shown. In addition, each vane 48 may also have a leading edge 60 and a trailing edge 56. As best shown in FIGS. 4-5, the inner endwall 68 may have a series of lower platforms 78 which may or may not be separate components and each lower platform 78 may have a slot (not shown) configured to receive and support the hub portion 72 of one of the vanes 48 in the guide vane assembly 38. Likewise, the outer endwall 70 may have a series of aligned upper platforms 80 which may or may not be separate components and each may have a slot (not shown) configured to receive and support the tip portion 76 of one of the vanes 48 in the guide vane assembly.

Importantly, each slot of each lower platform 78 and each slot of each upper platform 80 should be individually designed to match the geometry of the vane camber at the hub and tip portions, respectively, such that unique upper and lower platforms should be manufactured for each guide vane class in the guide vane assembly 38. In other words, for each guide vane class (nominal vanes 66, plus ten vanes 62, minus ten vanes 64, and all others), a corresponding lower platform 78 and a corresponding upper platform 80 should be manufactured, leading to an increasing number of required parts and associated costs when increasing types of guide vane classes are utilized in the guide vane assembly 38. Furthermore, engine design requirements may require the placement of certain components within the passages 82 between adjacent vanes 48 (see FIG. 3) of the guide vane assembly. However, because the size and shape of the passages 82 between adjacent vanes 48 may vary depending on the respective cambers of the adjacent guide vanes, whether nominal or off-cambered, engine components needing to fit within the passages 82, such as contoured endwalls, need to be scaled and adjusted according to each passage size and shape, thereby further increasing part numbers and associated costs when the camber variation method is employed.

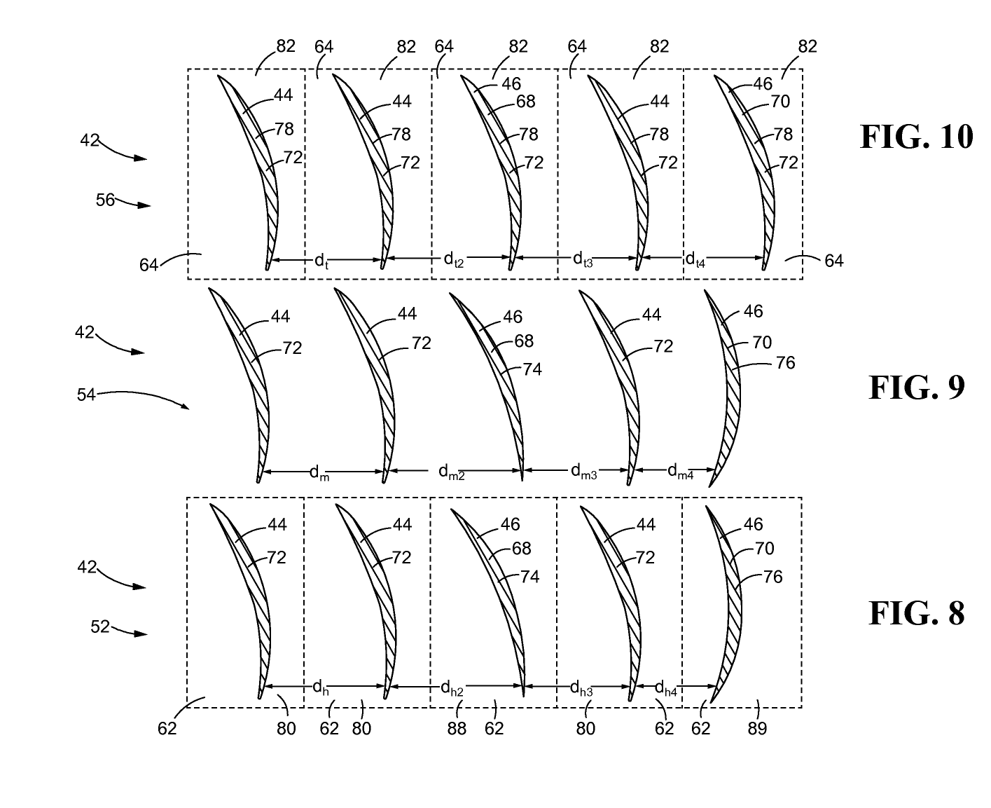

The number and complexity of parts (including the lower platforms 78, the upper platforms 80, and any components required to fit within passages 82) when employing off-cambered vanes 53 may be further appreciated by reference to FIGS. 6-8. FIG. 6, FIG. 7, and FIG. 8 are cross-sectional views illustrating the geometries of the hub portions 72, the mid-span portions 74, and the tip portions 76, respectively, for five vanes 48 arranged in the following exemplary sequence from left to right: nominal vane 66, nominal vane 66, off-cambered vane 53 (as the minus ten vane 64), nominal vane 66, and off-cambered vane 53 (as the plus ten vane 62). The nominal vanes 66 may adopt a nominal geometry 84 at the hub portions 72, the mid-span portions 74, and the tip portions 76. In contrast, the minus ten vane 64 may adopt a minus ten geometry 86 at the hub portion 72, the mid-span portion 74, and the tip portion 76. Likewise, the plus ten vane 62 may adopt a plus ten geometry 88 at the hub portion 72, the mid-span portion 74, and the tip portion 76. It should be noted that, for clarity purposes, the hub portions 72, the mid-span portions 74, and the tip portions 76 of the off-cambered vanes 53 are shown in FIGS. 6-8 as having identical geometries, but in reality an off-cambered vane may exhibit varying geometries along the length of the vane. For example, the plus ten vane 62 may have slightly different cambers at the tip portion 76 than at the hub portion 72.

As illustrated in FIGS. 6, three separate types of the lower platforms 78 (lower platforms 90, 92, and 94) may be required to provide suitable slot geometries for receiving the hub portions 72 of the nominal vanes 66, the minus ten vane 64, and the plus ten vane 62, respectively. Similarly, as shown in FIG. 8, three separate types of upper platforms 80 (upper platforms 96, 98, and 99) may be required to accommodate the tip portions 76 of the nominal vanes 66, the minus ten vane 64, and the plus ten vane 62, respectively. Furthermore, the varying guide vane cambers in the sequence leads to different distances between adjacent vanes, particularly at regions proximal to the trailing edges 56. For example, the distance, dₕ, between the two nominal vanes 66 at the hub portions 72 may be shorter than the distance, dₕ₂, between the nominal vane 66 and the minus ten vane 64, but may be longer than the distance, dₕ₄, between the nominal vane 66 and the plus ten vane 62, as shown in FIG. 6. Similarly, at the tip portions 76, the distance, dₜ, between the two nominal vanes 66 may be shorter than the distance, dₜ₂, between the nominal vane 66 and the minus ten vane 64, but may be longer than the distance, dₜ₄, between the nominal vane 66 and the plus ten vane 62, as shown in FIG. 8. As such, parts designed to fit in the passages 82 must be scaled and dimensioned accordingly. It can be understood that the number and complexity of part design will therefore increase with increasing numbers of guide vane classes and combinations of adjacent guide vanes.

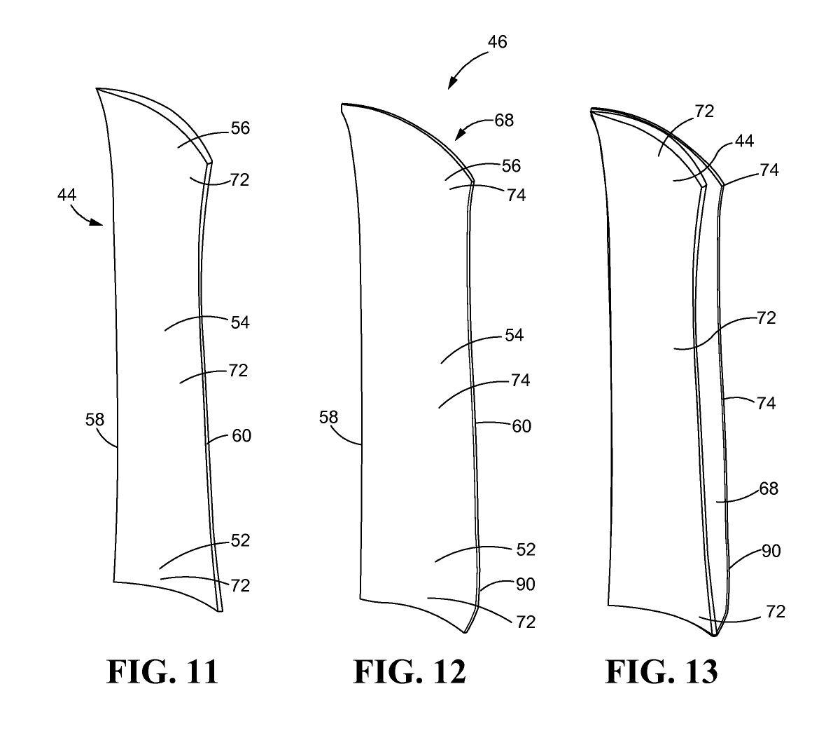

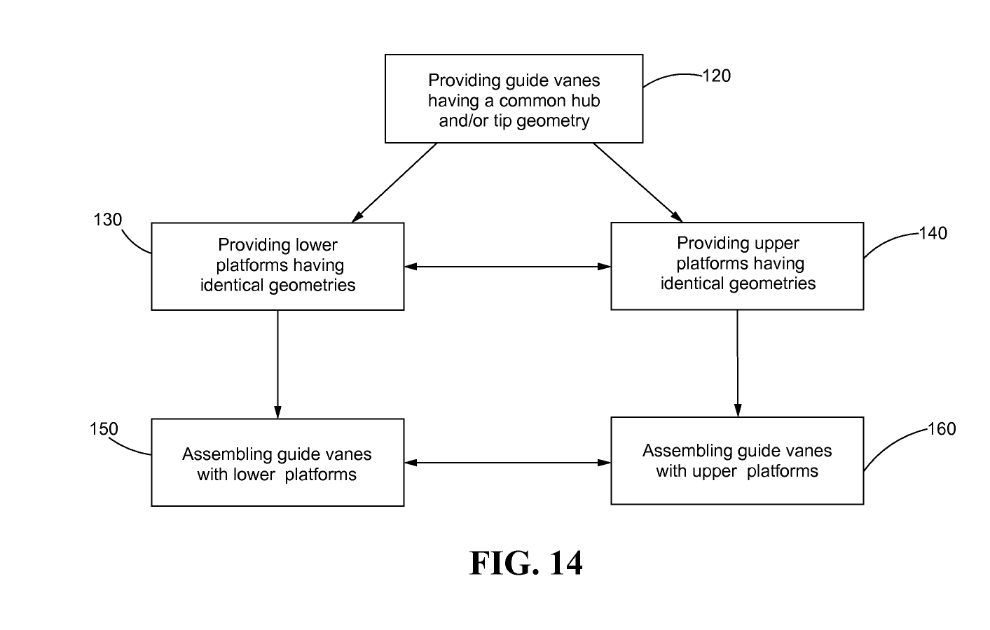

In order to reduce the number of different types of parts and associated costs required for construction of the guide vane assembly 38 and the gas turbine engine 10, modified off-cambered vanes 100 (see FIGS. 9-11 and FIGS. 12-14) may be introduced into the guide vane assembly 38. The modified off-cambered vanes 100 may be provided by altering the geometries of the off-cambered vanes 53 (i.e., the minus ten vanes 64, the plus ten vanes 62, and all other off-cambered vane types) at the hub portions 72 and/or tip portions 76 to form a common geometry such that the hub portions 72 and/or tip portions 76 of all the vanes 48 in the assembly are receivable by lower platforms and/or upper platforms having identical geometries. The common geometry at the hub portions 72 and/or tip portions 76 of the modified off-cambered vanes 100 may be the nominal geometry 84, but other common geometries may suffice if the nominal vanes 66 in the assembly are also altered at their hub portions and/or tip portions to form the common geometry. The common geometries at the hub portions 72 and/or tip portions 76 of all vanes, both nominal and off-cambered, may lead to advantageous reductions in required part numbers and costs while minimally interfering with the ability of the modified off-cambered vanes 100 to direct airflow around any obstructions 52 (see further details below).

Referring now to FIGS. 9-11, a series of vanes 48, including nominal vanes 66 and modified off-cambered vanes 100, each having a common geometry at the hub portions 72 is depicted. Specifically, a series of vanes are shown arranged in the following exemplary sequence from left to right: nominal vane 66, nominal vane 66, modified off-cambered vane 100 (as a modified minus ten vane 102), nominal vane 66, and modified off-cambered vane 100 (as a modified plus ten vane 104). The mid-span portion 74 and the tip portion 76 of the modified minus ten vane 102 may both adopt the minus ten geometries 86, and therefore may have cambers and geometries that deviate with respect to the nominal geometry 84, whereas the hub portion 72 may adopt the nominal geometry 84, as shown. Likewise, the modified plus ten vane 104 may exhibit plus ten geometries 88 at the mid-span portion 74 and the tip portion 76 and the nominal geometry 84 at the hub portion 72. The common hub geometries may reduce the number of required lower platform parts to one (lower platform 90), as only the nominal hub dimensions require accommodation, as shown. Furthermore, proximal to the hub portions 72, the distances, dₕ, between adjacent vanes near the trailing edges 56, as well as the dimensions of the passages 82 between adjacent vanes, may be equivalent or at least substantially equivalent. Accordingly, engine components required to fit within the passages 82 proximal to the hub portions 72 should not require scaling as each of the passages 82 would be identical regardless of the camber of the neighboring vanes. Although the common geometry of the hub portions 72 illustrated in FIGS. 9-11 is the nominal geometry 84, it will be understood that other types of common geometries may also provide similar reductions in part numbers and costs, if the hub portions of the nominal vanes 66 also adopt the common geometry.

Alternatively, the off-cambered vanes 53 may be adapted to conform to a common geometry at the tip portions 76, as illustrated in FIGS. 12-14. FIGS. 12-14 shows a series of vanes arranged in the following exemplary sequence from left to right: nominal vane 66, nominal vane 66, modified off-cambered vane 100 (as a modified minus ten vane 106), nominal vane 66, and modified off-cambered vane 100 (as a modified plus ten vane 108). The modified minus ten vane 106 may exhibit the minus ten geometry 86 at the hub portion 72 and the mid-span portion 74 and the nominal geometry 84 at the tip portion 76, as shown. Similarly, the modified plus ten vane 108 may exhibit the plus ten geometry 88 at the hub portion 72 and the mid-span portion 74 and the nominal geometry 84 at the tip portion 76. With such an arrangement, the type of upper platforms 80 required for the guide vane assembly 38 may be reduced to one (upper platform 96) as only one type of guide vane tip geometry (nominal geometry 84) requires accommodation. In addition, the distances, dₜ, between adjacent vanes near the trailing edges 56 at the tip portions 76 may be equivalent or at least substantially equivalent, as shown, and the geometry of the passages 82 between adjacent vanes proximal to the tip portions 76 may also be equivalent or at least substantially equivalent. As explained above, such an arrangement may reduce the part design complexity, part numbers, and costs required for guide vane assembly 38 and engine 10 construction. Alternatively, the tip portions 76 of the off-cambered vanes may be adapted to form another type of common geometry if the tip portions of the nominal vanes 66 are also modified to form the common geometry, while still achieving similar reductions in part numbers and costs.

As another alternative arrangement, both the tip portions 76 and the hub portions 72 of the off-cambered vanes 53 may be adapted to form a common geometry, such as the nominal geometry 84, to even further reduce part design complexity, part count, and related costs. It is further noted that all classes of off-cambered vanes 53, such as minus six vanes, minus two vanes, plus six vanes, etc., may be modified as demonstrated in FIGS. 9-11 and FIGS. 12-14 to provide a common geometry at the hub and/or tip portions.

Distinctions between the structures of the nominal vane 66 and the modified minus ten vane 102 are depicted in FIGS. 15-17. In particular, as shown in FIG. 15, the nominal vane 66 may adopt the nominal geometry 84 at the tip portion 76, the mid-span portion 74, and the hub portion 72. In contrast, the modified minus ten vane 102 may adopt the minus ten geometries 86 at the tip portion 76 and the mid-span portion 74 and the nominal geometry 84 at the hub portion 72, as shown in FIG. 16. Adaptation of the hub portion 72 of the modified minus ten vane 102 may be achieved by introducing curvature 110 along the trailing edge 56 below the mid-span portion 74, as shown in FIG. 16. The common geometry (the nominal geometry 84) of the hub portions 72 of the nominal vane 66 and the modified minus ten vane 102 is further illustrated in FIG. 17, where the two vanes (the nominal vane 66 and the modified minus ten vane 102) are shown are overlapped. Those of ordinary skill in the art will understand that similar curvature may be introduced near the tip and/or hub portions of all other classes of off-cambered vanes 53 to produce common geometries at the hub and/or tip portions. Those of ordinary skill in the art will also understand that, depending on engine design considerations and other factors, the common geometry at the hub and/or tip portions may deviate from the nominal geometry 84 and may be off-cambered, while still achieving desired reductions in part numbers and costs.

Referring now to FIG. 18, steps which may be involved in constructing the guide vane assembly 38 in accordance with the present disclosure are illustrated. Starting with a block 120, vanes 48, including nominal vanes 66 and modified off-cambered vanes 100, having common geometries at the tip portions 76 and/or the hub portions 72 may be provided. As described above and illustrated in FIGS. 9-11 and FIGS. 12-14, the common geometry of the vanes 48 at the tip portions 76 and/or the hub portions 72 may be the nominal geometry 84. If vanes having a common hub geometry are provided, lower platforms having identical geometries configured to receive the hub portions 72 of each vane may be provided according to a block 130. Each vane 48 may then be assembled with a lower platform according to a block 150. Likewise, if vanes having a common tip geometry are provided, upper platforms having identical geometries configured to receive the tip portions 76 of each vane may be provided and each vane 48 may be assembled with an upper platform according to a block 140 and a block 160, respectively. However, if guide vanes having common geometries at both the hub portions 72 and the tip portions 76 are provided, both lower platforms having identical geometries and upper platforms having identical geometries may be provided (blocks 130 and 140) and each guide vane may be assembled at its hub portion 72 with a lower platform (block 150) and at its tip portion 76 with an upper platform (block 160). The skilled artisan will understand any remaining steps involved in completing the construction the guide vane assembly 38.

### INDUSTRIAL APPLICABILITY

In general, it can therefore be seen that the technology disclosed herein may have industrial applicability in a variety of settings including, but not limited to, gas turbine engine construction. In particular, the technology disclosed herein introduces off-cambered vanes that are modified to form a common geometry at the tip and/or hub portions such that the number and costs for parts required for engine and guide vane assembly construction may be significantly reduced. Furthermore, the modification of the off-cambered vanes to present a common hub and/or tip geometry may minimally interfere with the ability of the off-cambered vanes to direct airflow around obstructions in the bypass duct. Therefore, it is expected that the off-cambered vanes having a common hub and/or tip geometry as disclosed herein may lead to substantial reductions in gas turbine engine construction costs and design complexity without significantly compromising engine operation.

While only certain embodiments have been set forth, alternative embodiments and various modifications will be apparent from the above descriptions to those skilled in the art. These and other alternatives are considered equivalents and within the spirit and scope of this disclosure.

What is claimed is:

1. A guide vane assembly for a gas turbine engine comprising:
a nominal vane having a tip portion, a mid-span portion, and a hub portion, the mid-span portion adopting a nominal geometry, the hub portion adopting a common geometry; and
an off-cambered vane having a tip portion, a mid-span portion, and a hub portion, the mid-span portion having a geometry deviating variably with respect to the nominal geometry, at least one of the hub portion and the tip portion adopting the common geometry.

2. The guide vane assembly of claim 1, wherein the nominal geometry is configured to assist directing airflow in a direction parallel to a central axis of the gas turbine engine.

3. The guide vane assembly of claim 2, further comprising lower platforms having identical geometries, the hub portions of the nominal vane and the off-cambered vane each being receivable by a respective one of the lower platforms.

4. The guide vane assembly of claim 3, further comprising equivalent geometries proximal to the adjacent hub portions.

5. The guide vane assembly of claim 3, wherein the common geometry is a nominal geometry.

6. The guide vane assembly of claim 3, wherein the off-cambered vane is configured to assist directing airflow at variable angles with respect to the central axis.

7. The guide vane assembly of claim 3, wherein the tip portion of the off-cambered vane has a geometry that deviates variably with respect to the nominal geometry.

8. The guide vane assembly of claim 3, wherein both the tip portions and the hub portions of the off-cambered vane adopt the common geometry.

9. The guide vane assembly of claim 8, wherein the common geometry is a nominal geometry.

10. The guide vane assembly of claim 8, further comprising upper platforms having identical geometries, the tip portions of the nominal vane and the off-cambered vane each being receivable by a respective one of the upper platforms.

11. An off-cambered vane for a guide vane assembly of a gas turbine engine comprising:
a tip portion;
a mid-span portion having a geometry that deviates variably with respect to a nominal geometry; and
a hub portion adopting the nominal geometry.

12. The off-cambered vane of claim 11, wherein the hub portion is receivable by a lower platform configured to receive a hub portion of a nominal vane.

13. The off-cambered vane of claim 12, wherein the tip portion has a geometry that deviates variably with respect to the nominal geometry.

14. The off-cambered vane of claim 12, wherein the tip portion adopts the nominal geometry.

15. The off-cambered vane of claim 14, wherein the tip portion is receivable by an upper platform configured to receive a tip portion of a nominal vane.

16. A gas turbine engine, comprising:
a fan;
a compressor downstream of the fan;
a combustor downstream of the compressor;
a turbine downstream of the combustor;
a nacelle surrounding the fan, the compressor, the combustor, and the turbine;
a guide vane assembly located between the nacelle and the fan, the compressor, the combustor, and the turbine, the guide vane assembly comprising a nominal vane and an off-cambered vane each having a tip portion, a mid-span portion, and a hub portion, the mid-span portion of the off-cambered vane having a geometry that deviates variably with respect to a nominal geometry, at least one of the hub portion and the tip portion of the off-cambered vane adopting a common geometry; and
lower platforms having identical geometries, each lower platform receiving the hub portion of a respective one of the nominal vane and the off-cambered vane.

17. The gas turbine engine of claim 16, wherein the common geometry is the nominal geometry.

18. The gas turbine engine of claim 16, wherein the tip portion of the off-cambered vane has a geometry that deviates variably with respect to the nominal geometry.

19. The gas turbine engine of claim 16, wherein both the tip portion and the hub portion of the off-cambered vane adopt the common geometry.

20. The gas turbine engine of claim 19, further comprising upper platforms having identical geometries, each upper platform receiving the tip portion of a respective one of the nominal vane and the off-cambered vane.
